(19) United States
(12) Patent Application Publication
(10) Pub. No.: US 2012/0020216 A1
(43) Pub. Date: Jan. 26, 2012

(54) COGNITIVE NETWORK LOAD PREDICTION METHOD AND APPARATUS

(75) Inventors: Akshay Vashist, Plainsboro, NJ (US); Alexander Poylisher, Brooklyn, NY (US); Siun-Chuon Mau, Princeton Junction, NJ (US); Abhrajit Ghosh, Edison, NJ (US); Ritu Chadha, Hillsborough, NJ (US)

(73) Assignee: TELCORDIA TECHNOLOGIES, INC., Piscataway, NJ (US)

(21) Appl. No.: 13/004,324

(22) Filed: Jan. 11, 2011

Related U.S. Application Data
(60) Provisional application No. 61/295,207, filed on Jan. 15, 2010.

(51) Int. Cl. H04L 12/26

(52) U.S. Cl. 370/235; 370/253

(57) ABSTRACT

Loads for a wireless network having a plurality of end nodes are predicted by constructing a computer data set of end-to-end pairs of the end nodes included in the network using a computer model of the network; constructing a computerized set of observables from social information about users of the network; developing a computerized learned model of predicted traffic using at least the data set and the observables; and using the computerized learned model to predict future end-to-end network traffic.

### CROSS REFERENCE TO RELATED APPLICATIONS

This application claims the benefit of U.S. Provisional Patent Application No. 61/295,207 filed Jan. 15, 2009 which is incorporated by reference as if set forth at length herein.

### BACKGROUND

1. Technical Field

The present invention relates to the prevention of network overload conditions by use of network load prediction methods and apparatus.

2. Description of the Related Art

The performance of communication networks is often quantified by their ability to support traffic and is based on network-oriented measurements, such as data rate, delay, bit error rate, jitter, etc. Usually, performance defined using different network-centric metrics establishes the QoS (Quality of Service) that can be provided by the network. This is important when network resources, especially capacity, are insufficient.

Relevant QoS metrics may differ depending on the application and user requirements, such as delay for real-time applications, including streaming content, online video games, jitter for voice-over IP, etc. There has been a lot of research in providing QoS guarantees in wired networks where nodes do not move and the physical capacity is fixed. Despite these efforts, existing solutions for wired networks are complex and impractical, and a universal and satisfactory solution is still lacking.

The difficulty of providing a QoS guarantee is even more complicated for mobile ad, hoc networks (MANETs), where the lack of wired connections, movement of nodes result in constrained and fluctuating resources, including link capacities.

MANETs inherently have limited and fluctuating bandwidths, and need to support applications with dynamic resource requirements. This is a complex problem because, in addition to variability in underlying network topology and capacity, user and application requirements are not known in advance.

Known techniques for network admission control rely on measuring network performance parameters and operate as and when performance deterioration is observed. Once performance deterioration is observed, the admission control mechanism usually admits traffic based on requested priorities and throttles low-priority traffic until measurements indicate acceptable conditions. Current admission control is not necessarily excercised at the traffic source but may also be applied to transit traffic, which leads to inefficient use of resources since such traffic has already consumed resources. Further, admission control may take drastic steps to recover from a poor performance state.

Such an approach to manage and control a network is fundamentally flawed for two reasons. First, it is, by nature, a reactive approach that becomes effective as a repair and maintenance mechanism rather than as a preventive mechanism. Secondly, it is oblivious to dynamic changes in user requirements and their communication context, satisfying which is the very purpose of networks as a service.

Due to their limited and fluctuating bandwidth, MANETs are inherently resource-constrained. As traffic load increases, it must be decided when and how to throttle the traffic to maximize overall user satisfaction while keeping the network operational. The current state of the art for making these decisions is based on network measurements and so employs a reactive approach to a deteriorating network state by reducing the amount of traffic admitted into the network.

There is a significant amount of past research on predicting network load based on historical data. The past known work involves predicting network-wide load as opposed to end-to-end traffic, and it only exploits patterns of network usage observed in the past. Although many techniques have been proposed to address this problem, the setup of the prediction problem remains very coarse as it fails to provide sufficient granularity in network load prediction to be of any value in exercising control and management of network resources.

Future network traffic load prediction is a widely studied problem. Load prediction usually arises as a subproblem to achieve a solution to a larger problem. Existing known research has been motivated by resource planning problems, such as predicting a maximum amount of physical bandwidth required to support future traffic, estimating what type of traffic dominates at a given time, planning for a given scenario, and balancing computational load in distributed resources via network load prediction.

Moreover, such problems are studied for wired networks. Thus, the problem is justifiably formulated as predicting the traffic load at the backbone or near the backbone of a network. The traffic at the backbone of a wired network is highly aggregated traffic as one expects to observe a spatially averaged traffic generated at or destined to a large number of nodes. This averaging effect smooths out the hard-to-model variability in traffic observed at the sources. Consequently, the aggregated traffic observed near the backbone varies more smoothly and becomes amenable to prediction.

Since the aggregated traffic at the backbone is usually smooth (especially compared to traffic observed at the source or destination), historical observations on such traffic carry enough signal to successfully model it as a time-series prediction problem. A variety of time-series prediction algorithms such as regression, autoregression moving averages, neural network, and support vector regression have been used in the past. Essentially, they select an embedding dimension for the time series (number of relevant historical observations) and learn a function to predict the value of the series at a near future time point.

### SUMMARY

A better approach, however, is to avoid congestion before it occurs, by (a) monitoring a computerized network for early onset signals of congestive phase transition, and (b) predicting future network traffic using user and application information from the overlaying social network derived from outside the computerized network.

Machine learning methods may be used to predict the amount of traffic load that can be admitted without transitioning the network to a congestive phase and to predict the source and destination of near future traffic load. These two predictions, when used by an admission control component, ensure better management of constrained network resources while maximizing user experience.

In a preferred embodiment, the present invention employs user information (one or more of behavior, profile, state, social organization, future plan, location, interaction patterns with other users, disposition, historical network usage, etc.) and/or application information (type, state, historical patterns of network usage, interactions with other applications, etc.) to predict future traffic. To realize this ability, use is preferably made of large-margin, kernel-based statistical learning methods to enable network load prediction under various scenarios of availability of user and application information.

The capability to predict end-to-end network traffic load can be enhanced by using information about entities that generate the traffic. This is especially true for short, bursty network flows and other dynamic parts of the traffic that cannot be modeled well using historical information alone. Since the users and applications sitting above the communication network are actually responsible for generating traffic, information about them can help improve future traffic prediction.

In summary, information about the entities (users and applications) that generate the traffic can be used to predict network traffic load, which in turn can be used to improve management and control of networks to enhance network performance as perceived by users.

Thus, the present invention may take the form of a method for predicting loads for a wireless network having a plurality of end nodes, comprising: constructing a computer data set of end-to-end pairs of the end nodes included in said network using a computer model of the network; constructing a computerized set of observables from social information about users of the network derived from outside the wireless network itself; developing a computerized learned model of predicted traffic using at least the data set and the observables; and using the computerized learned model to predict future end-to-end network traffic.

Moreover, the method may further use historical traffic data to develop the learned model.

Preferably the method may further comprise modifying the network to reduce future network congestion by applying the prediction to the network.

Still further, the method may also comprise obtaining at least one of new network information reflecting the dynamic changes to the network and new social information about users of the network and applying that new information to the learned model to predict future end-to-end network traffic.

In a still further alternative embodiment of the present invention, there is provided a non-transitory computer-readable storage medium comprising instructions that, when executed in a system, cause the system to perform a method for predicting loads for a wireless network having a plurality of end nodes, the method comprising the steps of: constructing a computer data set of end-to-end pairs of the end nodes included in the network using a computer model of the network; constructing a computerized set of observables from social information about users of the network; developing a computerized learned model of predicted traffic using at least the data set and the observables; and using the computerized learned model to predict future end-to-end network traffic.

It is important to understand that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate various embodiments. In the drawings:

FIG. 1 provides a schematic view of network operation to avoid congestion;

FIG. 2 provides an alternative view of network operation to avoid congestion; and

FIG. 3 illustrates queue length fluctuation as an early warning sign of phase transition in networks.

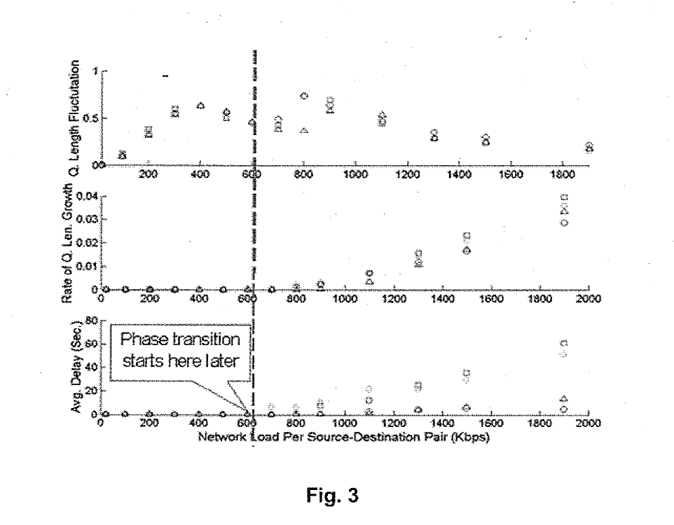

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings. Whenever possible, the same reference numbers will be used throughout the drawings to refer to the same or like parts.

One goal of the present invention is to keep the network away from congestion while maximizing its utility to the users. Effective admission control for congestion avoidance requires that unserviceable traffic be throttled at its origin rather than initially admitting such traffic and dropping it when conditions deteriorate. Such an admission control requires predicting traffic load at the source nodes. This perspective on network resources dictates end-to-end network traffic prediction rather than predicting traffic at the network backbone as motivated by an infrastructure planning perspective, which is widely studied in the existing literature.

End-to-end traffic is highly variable. The primary cause of such hard-to-model variability is the dominance of the so-called short flows (short-lived traffic) over long flows (a large amount of traffic that persists over a longer duration) in the end-to-end traffic in MANETs, most of which originate and terminate in the same MANET. Due to their short durations, such traffic cannot be predicted well based on historical traffic. In fact, short flows are present even in backbone traffic in the wired network, but due to aggregation of the traffic over a large number of nodes, it suffices to model them as noise or tiny fluctuations and focus on longer flows which dominate at the backbone level. However, in end-to-end traffic prediction for MANETs, short flows cannot be ignored and modeled as noise, as they constitute the majority of the traffic.

Due to the dominance of short flows, the end-to-end network traffic is highly dynamic, and historical traffic data alone is insufficient to model or predict it. So, one must use information that correlates well with the short flows. One such information relates to knowledge about entities responsible for generating the traffic. In other words, information about users and applications that reside at each node and generate traffic can be useful in making end-to-end traffic predictions. Predictions can be further improved by using additional information about the social network overlaying the communication network, organization and interactions between users, and applications utilized at different nodes. In a paper entitled “A new learning paradigm: Learning using privileged information,” [Vladimir Vapnik, Akshay Vashist: A new learning paradigm: Learning using privileged information. Neural Networks 22(5-6): 544-557 (2009)] the inventors demonstrate that such information is critical to predicting end-to-end traffic.

Support Vector Regression (SVR) may be trained using historical traffic patterns and information about applications and information about users at nodes in a network to predict future traffic. Specifically, predictions may be made when, in the future, a node in the network will transmit traffic. An root mean square (rms) error of about 2 minutes may be obtained, which is very impressive given the range of values to be predicted.

A preferred embodiment of the present invention involves applying machine learning techniques to improve network resource management to directly improve user experience. Towards this end, two new problems are addressed. The first problem is to predict the amount of future traffic a network can sustain without deteriorating in performance. Phase transitions in communication networks may be leveraged to make this prediction. The second problem is to predict end-to-end future traffic. Due to its highly dynamic nature, end-to-end traffic is poorly predictable. Existing research in network traffic load predictions is based on time-series models and focuses on predicting highly averaged traffic observed at or close to the network backbone. Since end-to-end traffic is poorly modeled using historical data alone, information from the social network of users, interactions between applications at different nodes, and other such information not present in the communication network is leveraged to improve prediction of this highly dynamic traffic.

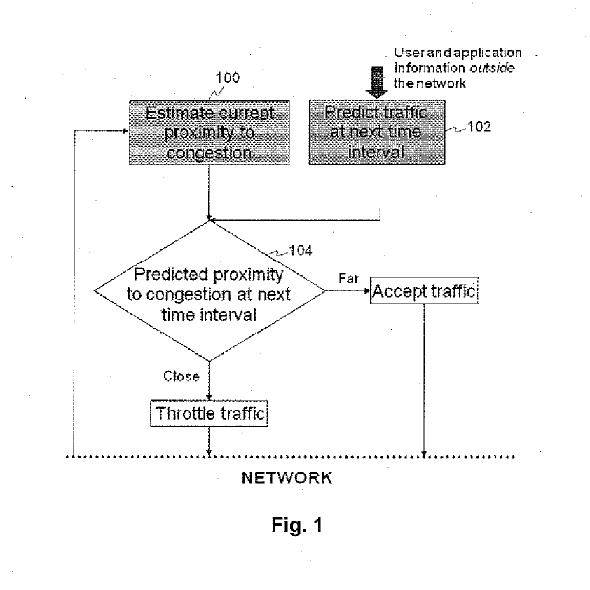

The proposed view of network operation to avoid congestion is shown in FIG. 1 (schema of network operation based on two prediction modules). The first module (100) predicts the admissible traffic load in a given network state. The second module (102) predicts the traffic generated at a node when information about the users and applications is available.

As mentioned above, congestion avoidance can be viewed as a result of two components: (a) the amount of traffic that can be admitted into the network without congesting it, and (b) the amount traffic generated at each node. In other words, in module 104, there is a prediction of the proximity of the current network state to the congestive state and a prediction of when and how much traffic each node is likely to generate.

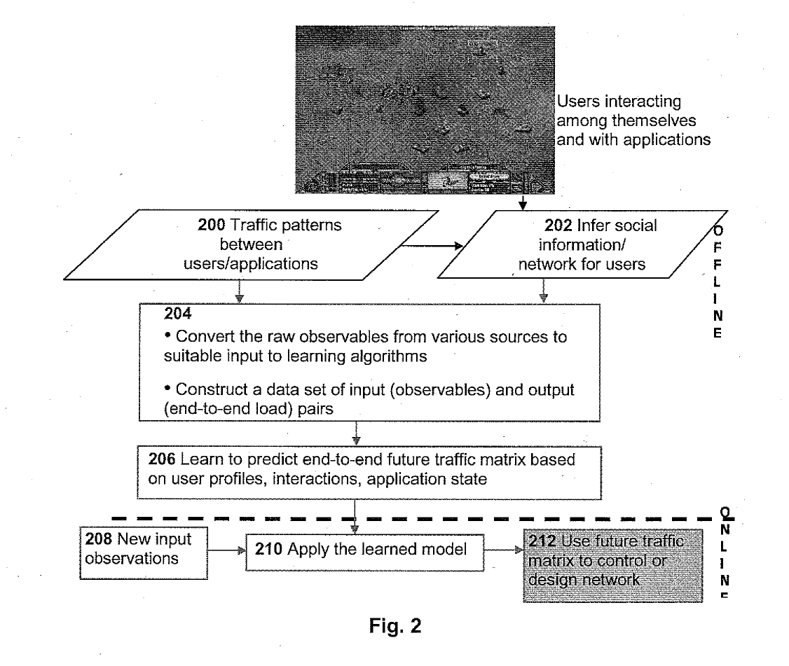

FIG. 2 illustrates a more detailed view of how the present invention may be implemented. Steps 200 and 202 gather information about entities situated beyond the computer network. Step 200 registers the communication or traffic load patterns between users/applications located at different network nodes (in other words, it observes end-to-end historical traffic load information). Step 202 collects context information about entities that actually control the communication, and such information may be user profiles, relationships between users/applications located at different nodes, their hierarchy, etc.

It is possible that such information may not be available or there may be restrictions on using such information (for instance, due to privacy concerns); in such cases, one could infer such information from historical communication patterns (step 200). Step 204 processes the raw data and converts it into a format (information) that can be processed by a learning algorithm.

After such conversion, a training data set is constructed wherein the inputs/observables are communication history and user/application information, and the output (values to be predicted) is the future traffic matrix. This data set is fed into the learning algorithm in step 206, which learns a function that maps the inputs to the outputs. The processing in steps 200, 202, 204, and 206 is traditionally offline, but can be made online for cases where the behavior of users and application might evolve over time. At the time of deployment, input data is obtained as past network traffic and current observations on users and applications in step 208.

Step 210 applies the learned model (from step 206) and applies the input from step 208 and predicts the future traffic matrix in step 212. Information about the future traffic matrix may be used for various purposes (managing, constructing, planning, controlling, etc.) in the network.

The goal of end-to-end traffic prediction is to estimate, at any time step t, the future traffic matrix M^{t÷1} at time t+1 for all source-destination pairs ((i,j), 1≦i,j≦n), given static information current information xᵢ^{t} (1≦i≦n), and historical information xᵢ^{t-Δ}, xᵢ^{t-Δ+1}, . . . , xᵢ^{t-1} (Δ>0) at each of the n nodes in the network. The vectors sᵢ and xᵢ^{t} will be described shortly. In reality, however, most pairs of nodes do not communicate with each other; therefore, the matrix M^{t} is usually very sparse and we need to focus only on predicting the non-zero entries of this matrix. Accordingly, the problem can be restated as given current and historical information xᵢ^{t-Δ}, xᵢ^{t-Δ+1}, . . . , xᵢ^{t-1}, xᵢ^{t} at each source i predict: (A) at what duration into the future will node i send traffic, (B) to which nodes will that traffic be destined, and (C) how much traffic will be sent to each of the destination nodes. Often, it is reasonable to limit the prediction to (a) future time when the traffic will be sent, and (b) how much traffic will be sent; this amounts to aggregating traffic across all destinations at a given time.

As described previously, each node in a preferred network is cognizant of users and applications associated with it. The information about various attributes of users and applications at node i is described by the vector sᵢ. The attributes include user profiles, social organization, hierarchy of users at different nodes, their interactions, etc., and this information does not change with time. The vector xᵢ^{t} contains traffic information for the node i at time t; it contains source, destination, time, and amount of traffic generated. Then our goal is to predict the quantities in problems (A)-(C), (a), and (b) using the input vector X^{t}ᵢ={sᵢ, xᵢ^{t}, xᵢ^{t-1}, . . . , xᵢ^{t-Δ}}, where Δ is a fixed constant specified a priori. Note that it is not the classical time-series prediction problem since much more information is used in addition to the usual historical information.

The output of prediction problems (A), (B), and (C) are regression, multi-class classification, and regression problems, respectively. Problem (a) is the same as problem (A), and problem (b) is regression. Since the same formulation is used for all regression problems, only the regression for problem (A) will be described. The goal is to estimate a positive real value regression function dᵢ^{t}=f(X^{t}ᵢ) to predict the duration (seconds) after time t when node i is likely to transmit the traffic. The regression function may be expected to be highly non-linear and, preferably, discrepancies within a prespecified threshold ε may be ignored. Furthermore, since traffic is being modeled at a very fine granularity, there is some component that cannot be modeled by the limited amount of user/application information, and advantage may be taken of the maximum margin-based approach to avoid overfitting on training data, especially when learning a non-linear function. These criteria motivate the use kernel-based SVR with e-insensitive loss function (see V. Vapnik, The Nature of Statistical Learning Theory, Springer-Verlag, 1995), which has been proven to be highly effective in handling noise and non-linearity (see M. Pontil, S. Mukherjee, and F. Girosi, “On the noise model of support vector machine regression,” Proc. Algorithmic Learning Theory 2000, LNCS 1968: pp. 316-324, 2000).

The non-linear function is then estimated using regression on the training data {(dᵢ^{t}, X^{t}ᵢ)}ᵢ₌₁^{n,}ₜ₌₁^{T}}, i.e., and the user information, traffic load, and subsequent transmission interval at all nodes until time T is observed and used to learn the function to predict the next future transmission time. An assumption may be made that this function is independent of network nodes or identical for all nodes and depends only on the user/application information and recent communication patterns, so there is a need to learn a single function that can be applied at all nodes. One could learn a separate function at each node, but it will considerably reduce the training data since the given data would have to be partitioned by n nodes and then used to learn n different functions.

To estimate the non-linear regression function, the input vectors X^{t}ᵢ in space X is set to a higher dimensional vector z^{t}ᵢ in space Z, where SVR estimates the regression function linear in Z as d^{t}ᵢ=wz^{t}ᵢ b, and where w and b have to be determined by minimizing the following functional:

$$R ( w , b ) = \frac{1}{2} {w}^{2} + C {\sum }_{i = 1 , t = 1}^{n , T} {\vert {d}_{i}^{t} - {wz}_{i}^{t} - b \vert}_{ɛ} ,$$

where u_{ε} is the E-insensitive loss defined as u_{ε}=0, if |u|<ε and u_{ε}=u, if |u|>ε. To minimize the functional, we solve the following equivalent optimization problem:

$${min}_{w , b} \frac{1}{2} {w}^{2} + C {\sum }_{i = 1 , t = 1}^{n , T} ( {ξ}_{i}^{t} + {ξ}_{i}^{* t} )$$

$$\begin{matrix}st . & {d}_{i}^{t} - {wz}_{i}^{t} - b \leq ɛ + {ξ}_{i}^{t} , & i = 1 , … n ; & t = 1 , … , T , \\ & {wz}_{i}^{t} + b - {d}_{i}^{t} \leq ɛ + {ξ}_{i}^{* t} , & i = 1 , … n ; & t = 1 , … , T ,\end{matrix}$$

where C is the parameter to the optimization problem and indicates the penalty for not fitting the data. For computational reasons and having to deal with mapping to space Z only implicitly, one invokes the kernel trick and solves the dual of the above problem (see V. Vapnik, The Nature of Statistical Learning Theory, Springer-Verlag, 1995, for details).

The problem (B) involving prediction of destination nodes is a multi-class classification problem. Due to the reasons described above and for consistency, we use SVM for learning an all-against-all binary classification whose results are then translated to infer the multiclass classification. The goal is to learn classification function y^{t}ᵢ=F(X^{t}ᵢ) from the training data {(y^{t}ᵢ, X^{t}ᵢ)}ᵢ₌₁^{n,}ₜ₌₁^{T}} where y^{t}ᵢ is the destination node for traffic generated at node i at time t. Ideally, the traffic can be destined to any of the n nodes in the network; however, a simplifying assumption may be made that any source node (user/application) sends traffic either to a node it has recently communicated with or to nodes whose users have a close social relationship with the user at this node. This assumption greatly reduces the number of classes, as the recent communications and the hierarchy of social organization is already present in the vector X^{t}ᵢ, and so y^{t}ᵢ is encoded as an index into the input vector.

Briefly, to solve a binary classification problem, SVM first maps the input vectors X^{t}ᵢ to higher dimensional vectors z^{t}ᵢ in space Z (similar to the regression case, but this space may be different from the one for the regression case) and estimates the classification function y=wz^{t}ᵢ+b; note that y is not the original class label but +/−1 indicating two of the multiple classes. In the space Z. SVM constructs a maximum margin hyperplane to linearly separate the vectors from the two classes. Margin is a measure of separation between the two classes, and it can be shown that maximizing overcomes the curse of dimensionality and leads to classifiers with good generalization performance.

When the margin of the hyperplane specified by (w,b) is related to 1/w², SVM constructs a maximum margin hyperplane by solving the following optimization:

$${min}_{w , b} \frac{1}{2} {w}^{2} + C {\sum }_{i = 1 , t = 1}^{n , T} {ξ}_{l}^{t}$$

$$\begin{matrix}s . t . & {y}_{i} [ {wz}_{i}^{t} + b ] \geq 1 - {ξ}_{i}^{t} , & i = 1 , … , n ; & t = 1 , … , T , \\ & {ξ}_{i}^{t} \geq 0 , & i = 1 , … , n ; & t = 1 , … , T ,\end{matrix}$$

where C is a user-specified parameter indicating the penalty for training vectors violating the margin criterion. As in the regression case, one usually solves the dual of the above optimization problem as it allows use of the kernel trick to implicitly model the non-linear mapping to higher dimensional spaces. As stated before, the multi-class classification is produced by learning and combining results of all-versus-all binary classifications.

Note that since prediction of problems (A)-(C) are dependent, it might be appropriate to treat them as a single problem by formulating a structured output prediction problem that can also be solved by maximum margin-based learning methods such as structured output SVMs. However, the training as well as testing (inference) complexity of structured output prediction methods is much higher, making them impractical for use in real-time systems such as network management and control.

### Congestive Phase Transition in Networks

It is well established in the science of phase transition that certain quantities undergo systematic and significant changes as a continuous phase transition (CPT) is approached and are considered advanced warning signs of a CPT. It has also been established that a phase transition to congestive phase also occurs in communication networks as traffic load increases. Then, the goal to operate a network in a state of good performance can be restated as avoiding congestive phase transition by watching for early warning signs of an impending phase transition. The queue length fluctuation may be used as an early warning sign of phase transition in networks (see FIG. 2 and R. Guimera, A. Arenas, A. Diaz-Guilera, and F. Giralt, “Dynamic properties of model communication networks,” Phys. Rev. E 66, 2002).

FIG. 2 illustrates a criticality warning sign of phase transition in queue length fluctuation as the network load increases. The actual CPT onsets when delay is significantly above 0 or the rate of queue length begins to increase. This data was obtained using an NS-3 simulator on a 10×10 grid network topology using multiple random runs. These plots are characteristic of various-sized networks and traffic variations.

### Predicting Congestive Criticality

A congestive phase may be avoided by predicting the congestive criticality point, which is operationally defined as network load when the queue length fluctuation begins to rise after reaching the peak (see the topmost plot in FIG. 2). Note that the critical load beyond which a network goes into congestive phase is constant and predictable if the variation is modeled in queue length fluctuation (with network load) as a mixture of two Gaussians and then identifies the transition (valley) between them. Since the congestive criticality is characteristic of the network, it can be predicted using the parameters of the network, such as its size, connectivity, etc. After determining the critical load, the problem of ensuring that a network operates away from congestion translates to avoiding the traffic from crossing the critical load. This can be done by estimating the current network load and future network load based on prediction models described in the previous section The computation involved in predicting the criticality can be distributed across the network and can work with sampled network traffic rather than a centralized approach requiring measurements at all nodes.

### Data

For end-to-end traffic prediction, network traffic data was collected from a simulation. The simulation describes traffic information for about 100 minutes in a MANET with 325 nodes, of which 318 acted as sources and 270 as destination at some point in the simulation interval. There were 7379 source destination pairs with roughly half a million flows entering the network. The traffic is dominated by short bursty flows—some short messages are sent once per minute while others only once every 30 minutes on average. Clearly, such traffic cannot be modeled and predicted well from historical data alone.

The Information Exchange Requirements (IERs) data from simulation provides information about users, assets, and applications at each of the nodes. The movement pattern or the 3D coordinates of the nodes were also available. Nodes exchanged different types of traffic, including video, command and control, heartbeat messages, network control messages, and fire and reconnaissance messages.

Each traffic flow is described by source, destination, time, data size, traffic type, priority, and position of source. Further, there is information about users at each node, describing the platform on which the node is mounted, the coded identification of the user/soldier, rank (commander, soldier, etc.), and hierarchical group membership (in platoon, company, batallion, squadron). The information on users, assets, and applications at node i is used as static information sᵢ, whereas the information related to traffic sent from node i at time t is used as xᵢ^{t}—it includes source, destination, traffic type, size, time, and priority.

The simulation data was actually generated according to a mission plan (as is the case in reality). The plan indicates the sequence of activities and related expected amount of traffic which also feeds into planning the network. However, as missions progress, they usually deviate from plans and one needs to predict the impact of the changes and deviations to update the plan. The accuracy of updates to these plans can be improved by incorporating user information and historical data with the original mission plan.

Unfortunately, there was no access to the mission plan that was used to generate the simulation data. So, multiple realizations of the single simulated data were created by treating the original data as if it were the plan, and randomly perturbing it 100 times (each perturbation was independent of other perturbations) to effectively obtain 100 different realizations of the same mission. During the perturbation, equivalent sets were first identified (based on resources and capabilities) of units in the mission, and the messaging between them was randomly exchanged in both time and space so that the overall mission does not change. Then, the original data was used as the plan template, while learning and prediction were done on the rest of the realizations of the mission.

### Experimental Results

Network Load Prediction

The 100 different realizations of the mission described above were randomly divided into three sets of sizes 50, 25, and 25. The set containing 50 realizations of the mission was used as the training set while the other two were used as a validation set for turning the free parameters in the learning model and as a test set for evaluating the performance of prediction. The goal was to learn four different functions (A), (B), (C), and (b), as stated above. These functions predict the time of transmitting traffic (A), amount of traffic to be transmitted (C) to the destination node predicted in (B), and the total amount of egress traffic from a given node.

For the regression case, E was fixed to be 0.5 seconds when predicting time and 50 bytes when predicting traffic size. The free parameters (C and the kernel hyperparameter) for both the regression and classification were tuned based on performance on the validation set. An RBF (radial basis function) kernel was used and searched for the parameter γ (inverse of the width of the Gaussian) in the range of 0.1 to 1e⁻⁵ using a grid search. Similarly, parameter C was searched in the range of 0.1 to 100. The best choice of parameters was slightly different for different problems.

We first report on predicting the traffic generated at nodes where we predicted the duration after which the next flow will originate and the size of that traffic. The duration to next flow ranges between 1 second to about 30 minutes, and the mean is concentrated around 5 minutes. The predicted value of this parameter across all the transmitting nodes had a root mean square (rms) error of ˜2 minutes; however, it must be emphasized that most of the contribution to rms is from traffic that is transmitted in the distant future (i.e., more than 10 minutes into the future). To provide another perspective on this result, we calculated the fraction of deviation from the actual time of traffic transmission and found this to be 20%; in other words, the duration of the next transmission was predicted within 20% of the actual time. As for the amount of traffic originating at a source node, the predictions had an rms error of 170 bytes, which is a good performance.

In the next set of experiments, we included the plan information in the input to guide the predictions. We correctly predicted about 60% of the communicating (source-destination) pairs. Although 60% accuracy appears low, one may note that this is a percentage of correctly predicted pairs (in contrast to sources or destinations alone), which is a harder problem than predicting individual senders or receivers. A completely random predictor will have an accuracy of less than 1%, while a random predictor that is constrained to predict only hierarchically related pairs will have a poor accuracy as well. Also, we were able to predict the transmission onset time of traffic within 10% of the actual communication onset time. Our results are significant for two reasons: (a) information beyond the computer networks can be used to predict network traffic; and (b) availability of such information enables modeling of short flows, which allows us to predict end-to-end traffic.

Congestive Criticality Prediction

Since the network load was obtained from a simulation, we did not have access to that network, so experiments for congestive criticality prediction were done on a different simulated network. Also, in reality, phase transition will happen for any topology. We simulated different traffic types and with different network loads on the NS-3 network simulator. Based on the network parameters and traffic type, we trained a regression model to predict the point of congestive criticality. Since the data for this was limited, we used cross-validation to assess the predictions performance and found predicted congestive criticality load was within 5% of the actual criticality load.

### CONCLUSION

Current network controls tend to be reactive and ineffective in highly dynamic networks like MANETs. We propose proactive control to avoid congestion before it occurs by (a) monitoring early onset signals of congestive phase transition, and (b) by predicting the future network traffic using user and application information from the overlaying social network. We have demonstrated that machine learning can greatly improve network management and operation by predicting quantities needed to make critical decisions.

End-to-end traffic load, which in MANETs is dominated by the hard-to-model short flows, can indeed be predicted to a good accuracy if one leverages information beyond the computer network. At first, it might seem hard to obtain such information, but in many performance critical scenarios, one has such information about the environment and context in which the communication takes place. Exposing such information to the computer network and making it cognizant of such information can improve its utility.

We have demonstrated the advantage of using machine learning in critical network management components. We believe there is great potential for machine learning in integrating social networks with communication networks. Our work also has implications for context-aware devices whose user friendliness can be improved while making them inter-operable with other devices by using inter-device contexts and information. With these problems in mind, new machine learning algorithms are being developed that can utilize information over very diverse spaces to improve performance in any single source of information.

The foregoing description of possible implementations consistent with the present invention does not represent a comprehensive list of all such implementations or all variations of the implementations described. The description of only some implementations should not be construed as intent to exclude other implementations. One of ordinary skill in the art will understand how to implement the invention in the appended claims in many other ways, using equivalents and alternatives that do not depart from the scope of the following claims.

The systems and methods disclosed herein may be embodied in various forms, including, for example, a data processor, such as a computer that also includes a database. Moreover, the above-noted features and other aspects and principles of the present invention may be implemented in various environments. Such environments and related applications may be specially constructed for performing the various processes and operations according to the invention or they may include a general-purpose computer or computing platform selectively activated or reconfigured by code to provide the necessary functionality. The processes disclosed herein are not inherently related to any particular computer or other apparatus, and may be implemented by a suitable combination of hardware, software, and/or firmware. For example, various general-purpose machines may be used with programs written in accordance with the teachings of the invention, or it may be more convenient to construct a specialized apparatus or system to perform the required methods and techniques.

Systems and methods consistent with the present invention also include non-transitory computer-readable storage media that include program instruction or code for performing various computer-implemented operations based on the methods and processes of the invention. The media and program instructions may be those specially designed and constructed for the purposes of the invention, or they may be of the kind well known and available to those having skill in the computer software arts. Examples of program instructions include, for example, machine code, such as produced by a compiler, and files containing a high-level code that can be executed by the computer using an interpreter.

It is important to understand that both the foregoing general description and the following detailed description are exemplary and explanatory only, and are not restrictive of the invention as claimed.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention. For example, one or more steps of methods described above may be performed in a different order or concurrently and still achieve desirable results.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method for predicting loads for a wireless network having a plurality of end nodes, comprising:
constructing a computer data set of end-to-end pairs of said end nodes included in said network using a computer model of said network;
constructing a computerized set of observables from social information about users of the network derived from outside the network itself;
developing a computerized learned model of predicted traffic using at least said data set and said observables; and
using said computerized learned model to predict future end-to-end network traffic.

2. The method of claim 1 further using historical traffic data to develop said computerized learned model.

3. The method of claim 1 further comprising:
modifying said network to reduce future network congestion by applying said prediction to said network.

4. The method of claim 1 further comprising:
obtaining at least one of new network information and new social information about users of the network and applying that new information to said computerized learned model to predict future end-to-end network traffic.

5. A non-transitory computer-readable storage medium comprising instructions that, when executed in a system, cause the system to perform a method for predicting loads for a wireless network having a plurality of end nodes, the method comprising the steps of:
constructing a computer data set of end-to-end pairs of the end nodes included in the network using a computer model of the network;
constructing a computerized set of observables from social information about users of the network;
developing a computerized learned model of predicted traffic using at least the data set and the observables; and
using the computerized learned model to predict future end-to-end network traffic.
